(19) United States
(12) Patent Application Publication
(10) Pub. No.: US 2022/0281445 A1
(43) Pub. Date: Sep. 8, 2022

(54) Method for Predicting a Future Driving Situation of a Foreign Object Participating in Road Traffic Device, Vehicle

(71) Applicant: Volkswagen Aktiengesellschaft, Wolfsburg (DE)

(72) Inventor: Volkmar Schöning, Wedemark (DE)

(73) Assignee: Volkswagen Aktiengesellschaft, Wolfsburg (DE)

(21) Appl. No.: 17/639,657

(22) PCT Filed: Aug. 26, 2020
(86) PCT No.: PCT/EP2020/073897

§ 371 Date: Apr. 18, 2022

(30) Foreign Application Priority Data
Sep. 2, 2019 (DE) 10 2019 213 222.7

(51) Int. Cl. B60W 30/095; B60W 60/00

(52) U.S. Cl. CPC B60W 30/0956; B60W 60/00274; B60W 2420/42; B60W 2554/402; B60W 2554/4041; B60W 2554/4042; B60W 2554/4046; B60W 2554/802

(57) ABSTRACT

The invention relates to a method for predicting a future driving situation of a foreign object, in particular a foreign vehicle, participating in road traffic, in which at least one first item of information is sensed which corresponds to at least one sensed first foreign object (3) participating in road traffic, and in which the first foreign object (3) is assigned to an object class on the basis of the first item of information. According to the invention, at least one second item of information is sensed, which corresponds to at least one sensed second foreign object (4) participating in road traffic and situated within the surroundings of the first foreign object (3), wherein the second foreign object (4) is assigned to an object class on the basis of the second item of information, and wherein a future position, a future driving speed and/or a future trajectory of the first foreign object (3) are predicted as future driving situations of the first foreign object (3) on the basis of the object class of the first foreign object (3) on the one hand and the object class of the second foreign object (4) on the other hand.

### CROSS-REFERENCE TO RELATED APPLICATIONS

This application claims priority to German Patent Application No. DE 10 2019 213 222.7, filed on Sep. 2, 2019 with the German Patent and Trademark Office. The contents of the aforesaid patent application are incorporated herein for all purposes.

### TECHNICAL FIELD

The disclosure relates to a method for predicting a future driving situation of a foreign object, in particular a foreign vehicle, participating in road traffic, wherein at least one first item of information is recorded which corresponds to at least one detected first foreign object participating in road traffic, and wherein the first foreign object is assigned to an object class on the basis of the first item of information.

Furthermore, the disclosure relates to a device for carrying out the above-mentioned method, and to a vehicle comprising such a device.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

EP 2 840 006 A1 discloses a method according to which a vehicle silhouette of a foreign vehicle participating in road traffic is detected as an item of information. In this case, the foreign vehicle is assigned to an object class or rather vehicle class on the basis of the detected vehicle silhouette. Then, a likely path of the foreign vehicle is predicted as the future driving situation on the basis of the vehicle class.

### SUMMARY

A need exists for a method that improves the reliability of the prediction of the future driving situation of a foreign object.

The need is addressed by the subject matter of the independent claims. Embodiments of the invention are described in the dependent claims, the following description, and the drawings.

### BRIEF DESCRIPTION OF THE DRAWINGS

FIG. 1 shows an example road on which an ego vehicle, a first foreign object and a second foreign object are being moved; and

FIG. 2 shows an embodiment of a method for predicting a future driving situation of the first foreign object.

### DESCRIPTION

The details of one or more embodiments are set forth in the accompanying drawings and the description below. Other features will be apparent from the description, drawings, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

An object of the teachings herein is to increase the probability of an actual future driving situation a first foreign object corresponding to the predicted future driving situation.

According to some embodiments, at least one second item of information is recorded which corresponds to at least one detected second foreign object participating in road traffic and situated within the surroundings of the first foreign object, wherein the second foreign object is assigned to an object class on the basis of the second item of information, and wherein a future position, a future travel speed and/or a future trajectory of the first foreign object are predicted as the future driving situation of the first foreign object on the basis of the object class of the first foreign object on the one hand and the object class of the second foreign object on the other hand. Therefore, the object class of the first foreign object as well as the object class of the second foreign object are taken into account during prediction of the future driving situation of the first foreign object. It is thereby assumed that at least two different possible object classes are present. The object classes differ from one another in that a foreign object assigned to a first object class of the object classes will likely change its driving situation in at least one particular traffic situation in a different manner to a foreign object assigned to a second object class of the object classes would in the same particular traffic situation. The future driving situation of the first foreign object is therefore influenced by the object class of the first foreign object. The second foreign object is situated within the surroundings of the first foreign object. It should therefore be assumed that the first foreign object or rather a driver of the first foreign object will take the second foreign object into account when changing its/their current driving situation. In particular, the object class of the second foreign object is relevant because the first foreign object or rather the driver of the first foreign object will associate a particular behavior of the second foreign object in road traffic with the object class of the second foreign object. By taking into account the object class of the first foreign object and the object class of the second foreign object, a reliable and particularly precise prediction of the future driving situation of the first foreign object is achieved. For example, the future driving situation of the second foreign object is predicted on the basis of a current driving situation of the second foreign object. The precisely predicted future driving situation of the first foreign object can then be used by other road users, for example in order to adapt a driving situation of said road users such that the distance from the first foreign object does not fall below a desired distance. A foreign object should, in principle, be understood to mean any foreign object that participates in road traffic. For example, a motor vehicle, a bicycle or a pedestrian is a foreign object. The future driving situation of the first foreign object is at least described by the future position, the future travel speed and/or the future trajectory of the first foreign object.

In some embodiments, it is provided that at least one visual image of the first and/or second foreign object is recorded as the first and/or second item of information. The visual image can be recorded in a technically simple manner, for example by means of a camera sensor. Moreover, the foreign objects can be assigned to an object class in a particularly reliable manner based on the visual image, for example based on a silhouette of the foreign objects and/or a size of the foreign objects. Furthermore, a particularly detailed assignment of the foreign objects to a correct object class is also possible based on the visual image. For example, it is established based on the visual image whether a detected motor vehicle is a truck, an agricultural vehicle, a passenger car or a motorcycle. The motor vehicle is then assigned to one of the object classes “truck”, “agricultural vehicle”, “passenger car” or “motorcycle”, accordingly.

For example, a present position, a present trajectory and/or a present travel speed of the first and/or second foreign object is detected as the first and/or second item of information. This allows for a particularly precise assignment of the foreign objects to a suitable object class. For example, it is established that a detected foreign motor vehicle is a foreign motor vehicle operated by a novice driver if it is established based on the present position of the foreign vehicle that the foreign motor vehicle is maintaining a relatively large distance from a foreign motor vehicle driving ahead, if a particularly cautious manner of driving is established based on the present trajectory and/or if a relatively slow driving behavior is established based on the present travel speed. The foreign vehicle is then assigned to the object class “motor vehicle, driver: novice driver”, for example. However, if the driving behavior is established to be average based on the present position, present trajectory and/or present speed of the foreign motor vehicle, the foreign motor vehicle is assigned to the object class “motor vehicle, driver: normal driver”, for example.

In some embodiments, it is provided that a driving style of a driver of the first foreign object is determined on the basis of the first item of information, wherein the first foreign object is assigned to the object class on the basis of the determined driving style. For example, a risky driving style of the driver or a cautious driving style of the driver is determined as the driving style on the basis of the first item of information. It is thereby assumed that the future driving situation is influenced by the driving style of the driver of the first foreign object. For example, a greater number of overtaking maneuvers can be expected for a driver with a risky driving style, whereas a driver with a cautious driving style will generally avoid overtaking maneuvers. By providing object classes that depend on the driving style and by assigning the foreign object to the object class on the basis of the determined driving style, the reliability of the prediction of the future driving situation is increased further. For example, a driving style of a driver of the second foreign object is determined on the basis of the second item of information, wherein the second foreign object is assigned to the object class on the basis of the determined driving style.

For example, the method is carried out in an ego vehicle. Therefore, an additional object participating in road traffic, namely the ego vehicle, is present in addition to the first foreign object and the second foreign object. By carrying out the method in the ego vehicle, the predicted future position may be taken into account during operation of the ego vehicle. For example, a warning signal that is perceptible to a driver of the ego vehicle is generated if a distance between the ego vehicle and the first foreign vehicle will likely fall below a distance threshold value on the basis of the predicted future driving situation of the first foreign vehicle.

For example, the first item of information and/or the second item of information is recorded by means of an environment sensor system of the ego vehicle. For example, the environment sensor system comprises at least one camera sensor, one radar sensor, one ultrasound sensor and/or one laser sensor. The ego vehicle itself therefore comprises the sensors by means of which the first item of information and/or the second item of information is recorded. External apparatuses that are not part of the ego vehicle are therefore not required for carrying out the method. As a result, the susceptibility of the method to errors is low.

In some embodiments, it is provided that the first foreign object is monitored as to whether it sends first data and/or the second foreign object is monitored as to whether it sends second data, wherein the first data and/or the second data are recorded as the first item of information and/or second item of information if it is detected that the first data and/or second data are sent. This produces the benefit that, firstly, the first foreign object and/or the second foreign object can provide particularly precise information relating, for example, to their travel speed on account of the sent data. Secondly, the method of this embodiment can be carried out even if the first foreign object and/or the second foreign object are not situated within a detection range of the environment sensor system of the ego vehicle, for example if one of the foreign objects is concealed by the other of the foreign objects.

In some embodiments, it is provided that an actual future driving situation of the first foreign object is compared with the predicted future driving situation, wherein, on the basis of the comparison, at least one first parameter which is assigned to the object class of the first foreign object and on the basis of which the future driving situation was predicted is replaced with a second parameter corresponding to the actual future driving situation. By replacing the first parameter, predictions carried out after replacement of the first parameter and relating to future driving situations of foreign objects assigned to this object class can be carried out more precisely. Machine learning methods that are generally known are used to determine the second parameter. For example, the first parameter is replaced if a deviation between the predicted future driving situation and the actual future driving situation exceeds a predefined threshold value. If the deviation is below the threshold value, the first parameter is for example retained.

In some embodiments, it is provided that a future driving situation of the second foreign object is predicted on the basis of the object class of the first foreign object on the one hand and the object class of the second foreign object on the other hand. As such, a future driving situation is predicted for each of the two foreign objects. The driving situation of other road users, for example the ego vehicle, can therefore be adapted taking into account the predicted future driving situation of the first foreign object and the predicted future driving situation of the second foreign object, such that the distance from the foreign objects does not fall below the desired distance. For example, the future driving situation of the second foreign object is predicted on the basis of the predicted future driving situation of the first foreign object. In particular, more than two foreign objects that participate in road traffic are detected, wherein at least one item of information that corresponds to the relevant foreign object is then recorded for each of the foreign objects, and wherein each of the foreign objects is assigned to an object class on the basis of the relevant item of information. A future driving situation is for example then predicted for each of the foreign objects. In this connection, the future driving situation is in each case predicted on the basis of the object class of the relevant foreign object and the object class of the foreign objects situated within the surroundings of the relevant foreign object.

In some embodiments, it is provided that a driving situation of the ego vehicle is automatically changed on the basis of the predicted future driving situation of the first foreign object and, optionally, the predicted future driving situation of the second foreign object. For example, a travel speed of the ego vehicle and/or a steering angle of the ego vehicle is automatically changed in order to change the driving situation of the ego vehicle if it is established on the basis of the predicted future driving situation of the first foreign object that a distance between the first foreign object and the ego vehicle would otherwise fall below the predefined distance threshold value in the future. Using an approach of this kind increases the operational reliability of the ego vehicle.

For example, the future driving situation of the first foreign object and, optionally, the future driving situation of the second foreign object are predicted on a running basis. As such, future driving situations of the first foreign object and, optionally, of the second foreign object predicted on a running basis are available in order to consistently achieve the benefits of the method. For example, for this purpose, the at least one first item of information and the at least one second item of information are recorded on a running basis, i.e., at several temporally consecutive points in time, such that at least one current first item of information and at least one current second item of information are always available for carrying out the method. The currently applicable first item of information and the currently applicable second item of information are then used at a particular point in time to predict the future driving situation.

In some embodiments, it is provided that the foreign object of the foreign objects that is at a lesser distance from the ego vehicle is detected as the first foreign object. The foreign object of the foreign objects that is at a greater distance from the ego vehicle is then detected as the second foreign object. For example, the distance is the distance in the direction of travel. It is particularly beneficial to predict the future driving situation of the foreign object that is at a lesser distance from the ego vehicle, because the future driving situation of said foreign object is particularly relevant to any changes in the driving situation of the ego vehicle.

In some embodiments, device for a motor vehicle comprises a unit for recording a first item of information which corresponds to a detected first foreign object participating in road traffic, and a second item of information which corresponds to a detected second foreign object participating in road traffic, said device being configured to predict a future driving situation of the first foreign object according to the method of the teachings herein. This also produces the above-mentioned benefits. Other features and combinations of features are apparent from that described above and from the claims.

In some embodiments, a vehicle is provided with the aforementioned device. This also produces the above-mentioned benefits. Other features and combinations of features are apparent from that described above and from the claims.

In some embodiments of the vehicle, the unit comprises an environment sensor system and/or a communication apparatus. The environment sensor system is for example designed to record at least one visual image of the first and/or second foreign object as the first item of information and/or second item of information. The communication apparatus is for example designed to receive first data sent by the first foreign object and/or second data sent by the second foreign object as the first item of information and/or second item of information.

Reference will now be made to the drawings in which the various elements of embodiments will be given numerical designations and in which further embodiments will be discussed.

In the exemplary embodiments described herein, the described components of the embodiments each represent individual features that are to be considered independent of one another, in the combination as shown or described, and in combinations other than shown or described. In addition, the described embodiments can also be supplemented by features other than those described.

Specific references to components, process steps, and other elements are not intended to be limiting. Further, it is understood that like parts bear the same or similar reference numerals when referring to alternate FIGS.

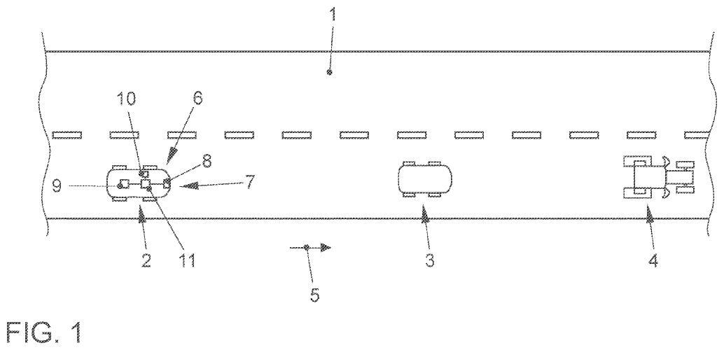

FIG. 1 shows a simplified representation of a road 1 on which an ego vehicle 2, a first foreign object 3 and a second foreign object 4 are being moved in a direction of travel 5. In the present case, the first foreign object 3 is a foreign vehicle 3, namely a passenger car 3. The second foreign object 4 is also a foreign vehicle 4 in the present case, namely an agricultural vehicle 4. The second foreign vehicle 4 is situated within the surroundings of the first foreign vehicle 3.

The ego vehicle 2 comprises a device 6 having an environment sensor system 7. The environment sensor system 7 comprises at least one environment sensor 8, which is designed to monitor the surroundings of the ego vehicle 2. In the present case, the environment sensor 8 is a camera sensor 8. Alternatively, the environment sensor 8 may be designed as a laser sensor, radar sensor or ultrasound sensor. For example, multiple such environment sensors arranged on the ego vehicle 2 so as to be distributed around the ego vehicle 2 are present. The ego vehicle 2 also comprises a communication apparatus 9. The communication apparatus 9 is designed to receive data sent by the first foreign vehicle 3, by the second foreign vehicle 4, by other foreign objects not shown here but participating in road traffic and/or by infrastructure apparatuses not shown here.

The device 6 also comprises a data memory 10. Object classes are stored in the data memory 10. The foreign vehicles 3 and 4 as well as other foreign objects participating in road traffic can be assigned to at least one of these object classes.

The device 6 also comprises a control unit 11. The control unit 11 is communicatively connected to the environment sensor 8, communication apparatus 9 and data memory 10.

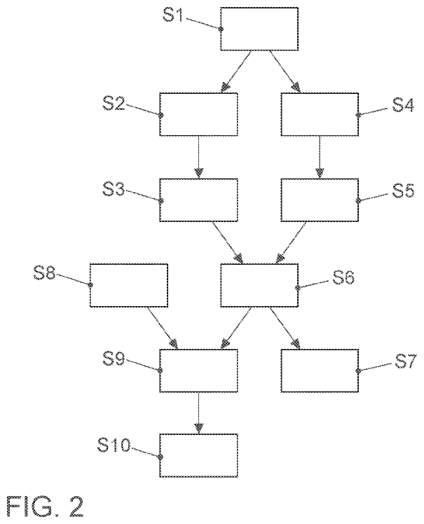

In the following, with reference to FIG. 2, a method for predicting a future driving situation of the first foreign vehicle 3 will be described using a flow diagram. In a first step S1, the method is started. In this regard, the environment sensor 8 starts detecting the surroundings of the ego vehicle 2 and the communication apparatus 9 starts monitoring whether the first foreign vehicle 3, the second foreign vehicle 4 or an infrastructure apparatus not shown here are sending data.

In a second step S2, the first foreign vehicle 3 is detected by means of the environment sensor 8. The environment sensor 8 designed as a camera sensor 8 records visual images of the first foreign vehicle 3. Based on the temporal sequence of the recorded visual images, the control unit 11 determines a present trajectory of the first foreign vehicle 3 and a present travel speed of the first foreign vehicle 3. The control unit 11 also determines a driving style of a driver of the first foreign vehicle 3 on the basis of the present trajectory and present travel speed. For example, the control unit 11 determines that the driver has a cautious driving style, as is often the case for novice drivers, for example, or a risky driving style, as is often the case for frequent drivers, for example. The visual images of the first foreign vehicle 3, the present trajectory of the foreign vehicle 3, the present speed of the foreign vehicle 3 and the driving style of the driver of the foreign vehicle 3 are first items of information.

In a step S3, the control unit 11 assigns the first foreign vehicle 3 to an object class of the object classes stored in the data memory 10 on the basis of the first items of information recorded or rather determined in the second step S2. In the present case, the control unit 11 assigns the foreign vehicle 3 to the object class “passenger car, driver: novice driver” based on the first items of information. Other possible, stored object classes are, for example, the object classes “passenger car, driver: normal driver”, “passenger car, driver: frequent driver”, “bus”, “garbage disposal vehicle”, “van”, “moving van”, “sewer cleaning vehicle”, “construction vehicle”, “bicycle, rider: child”, “bicycle, rider: adult”, “pedestrian”, “motorcycle rider” or “animal”. Of course, this list of object classes is not exhaustive, and other additional object classes are for example also provided.

Various first parameters are assigned to each object class. On the basis of the first parameters, it can be predicted how a foreign object assigned to the relevant object class will likely react in a particular traffic situation. Because it can be assumed therefrom that a foreign object assigned to a first of the object classes will react differently in a particular traffic situation to a foreign object assigned to a second of the object classes, different first parameters are assigned to each of the various object classes.

In a fourth step S4, the second foreign vehicle 4 is detected. In the present case, the second foreign vehicle 4 is initially detected by means of an environment sensor system of the first foreign vehicle 3 not shown here. The second foreign vehicle 4 cannot be detected by means of the environment sensor system of the ego vehicle 2, because the second foreign vehicle 4 is concealed by the first foreign vehicle 3. Nevertheless, the first foreign vehicle 3 sends data regarding the second foreign vehicle 4 by means of a communication apparatus not shown here. Said data are recorded in the fourth step S4 by means of the communication apparatus 9 of the ego vehicle 2.

In a step S5, the control unit 11 also assigns the second foreign vehicle 4 to an object class, in the present case the object class “agricultural vehicle”, on the basis of the data received by means of the communication apparatus 9.

In a sixth step S6, the control unit 11 predicts a future driving situation of the first foreign vehicle 3 on the basis of the object class of the first foreign vehicle 3 on the one hand and the object class of the second foreign vehicle 4 on the other hand. By way of example, the control unit 11 predicts a future travel speed, a future position and/or a future trajectory of the first foreign vehicle 3 as the driving situation. Because the second foreign vehicle 4 was assigned to the object class “agricultural vehicle”, it should generally be assumed that the first foreign vehicle 3 will overtake the second foreign vehicle 4. However, in the present case, the first foreign vehicle 3 was assigned to the object class “passenger car, driver: novice driver”. Based on the first parameters assigned to this object class, the control unit 11 therefore predicts that the first foreign object 3 will reduce its travel speed and drive behind the second foreign vehicle 4 as the future driving situation of the first foreign vehicle 3. If the first foreign vehicle 3 were assigned to the object class “passenger car, driver: frequent driver” in the third step S3, it would be predicted as the future driving situation based on the first parameters assigned to said object class that the first foreign vehicle 3 will increase its travel speed and change its trajectory in order to overtake the second foreign vehicle 4.

In a seventh step S7, a driving situation of the ego vehicle 2 is automatically changed on the basis of the predicted future driving situation of the first foreign vehicle 3. Because it was predicted that the first foreign vehicle 3 will drive behind the second foreign vehicle 3, a maneuver of the ego vehicle 2 for overtaking the first foreign vehicle 3 and the second foreign vehicle 4 is possible in the present case. Therefore, a travel speed of the ego vehicle 2 is increased and a trajectory of the ego vehicle 2 adapted in an automatic manner such that the ego vehicle 2 overtakes the first foreign vehicle 3 and the second foreign vehicle 4.

In an eighth step S8, the actual future driving situation of the first foreign vehicle 3 is detected. In a ninth step S9, the actual future driving situation detected in the eighth step S8 is compared with the predicted future driving situation.

In a tenth step S10, on the basis of the comparison, the first parameters assigned to the object class of the first foreign object 3 are replaced with second parameters corresponding to the actual future driving situation. If, for example, it is established in the comparison that the actual future driving situation deviates from the predicted future driving situation, at least one of the first parameters is replaced. However, if the comparison reveals that the actual future driving situation corresponds to the predicted future driving situation, the first parameters are for example retained.

For example, the future driving situation of the second foreign vehicle 4 is also predicted by means of the method. Because the object class of the second foreign vehicle 4 and the object class of the first foreign vehicle 3 are determined in the method anyway, this is easily possible without significant additional effort.

For example, the method steps S2 to S10 shown in FIG. 2 are carried out on a running basis. This results in a reliable running prediction of the future driving situation of the first foreign object 3 and, consequently, in automated control of the driving situation of the ego vehicle 2.

### LIST OF REFERENCE NUMERALS

1 Road
2 Ego vehicle
3 First foreign vehicle
4 Second foreign vehicle
5 Direction of travel
6 Device
7 Environment sensor system
8 Environment sensor
9 Communication apparatus
10 Data memory
11 Control unit

The invention has been described in the preceding using various exemplary embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, module or other unit or device may fulfil the functions of several items recited in the claims.

The term “exemplary” used throughout the specification means “serving as an example, instance, or exemplification” and does not mean “preferred” or “having advantages” over other embodiments. The term “in particular” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1. A method for predicting a future driving situation of a foreign object, participating in road traffic, comprising:
recording at least one first item of information which corresponds to at least one detected first foreign object participating in road traffic, and assigning the first foreign object to an object class depending on the first item of information;
recording at least one second item of information which corresponds to at least one detected second foreign object participating in road traffic and situated within the surroundings of the first foreign object, and assigning the second foreign object to an object class depending on the second item of information; and
predicting one or more of a future position, a future travel speed and a future trajectory of the first foreign object as the future driving situation of the first foreign object on the basis of the object class of the first foreign object and the object class of the second foreign object.

2. The method of claim 1, wherein at least one visual image of the first and/or second foreign object is recorded as the first and/or second item of information.

3. The method of claim 1, wherein one or more of a present position, a present trajectory and a present travel speed of the first and/or second foreign object is detected as the first and/or second item of information.

4. The method of claim 1, wherein a driving style of a driver of the first foreign object is determined depending on the first item of information, wherein the first foreign object is assigned to the object class depending on the determined driving style.

5. The method of claim 1, wherein the method is carried out in an ego vehicle.

6. The method of claim 5, wherein one or more of the first item of information and the second item of information are recorded using an environment sensor of the ego vehicle.

7. The method of claim 1, wherein the first foreign object is monitored as to whether it sends first data and/or the second foreign object is monitored as to whether it sends second data, wherein the first data and/or the second data are recorded as the first item of information and/or second item of information if it is detected that the first data and/or second data are sent.

8. The method of claim 1, wherein an actual future driving situation of the first foreign object is compared with the predicted future driving situation, wherein, depending on the comparison, at least one first parameter which is assigned to the object class of the first foreign object and depending on which the future driving situation was predicted is replaced with a second parameter corresponding to the actual future driving situation.

9. The method of claim 1, wherein a future driving situation of the second foreign object is predicted depending on the object class of the first foreign object and the object class of the second foreign object.

10. The method of claim 1, wherein a driving situation of the ego vehicle is automatically changed depending on the predicted future driving situation of the first foreign object and, optionally, the predicted future driving situation of the second foreign object.

11. The method of claim 1, wherein the future driving situation of the first foreign object and, optionally, the future driving situation of the second foreign object are predicted on a running basis.

12. The method of claim 1, wherein the foreign object of the foreign objects that is at a lesser distance from the ego vehicle is detected as the first foreign object.

13. A device for a vehicle, comprising a unit for recording a first item of information which corresponds to a detected first foreign object participating in road traffic, and a second item of information which corresponds to a detected second foreign object participating in road traffic, comprising a control unit, wherein the device is configured to predict a future driving situation of the first foreign object according to the method of claim 1.

14. A vehicle, comprising the device of claim 13.

15. The vehicle of claim 14, wherein the unit comprises one or more of an environment sensor and a communication interface.

16. The method of claim 2, wherein one or more of a present position, a present trajectory and a present travel speed of the first and/or second foreign object is detected as the first and/or second item of information.

17. The method of claim 2, wherein a driving style of a driver of the first foreign object is determined depending on the first item of information, wherein the first foreign object is assigned to the object class depending on the determined driving style.

18. The method of claim 3, wherein a driving style of a driver of the first foreign object is determined depending on the first item of information, wherein the first foreign object is assigned to the object class depending on the determined driving style.

19. The method of claim 2, wherein the method is carried out in an ego vehicle.

20. The method of claim 3, wherein the method is carried out in an ego vehicle.
